(19) United States
(12) Patent Application Publication
(10) Pub. No.: US 2013/0087206 A1
(43) Pub. Date: Apr. 11, 2013

(54) SAMPLE CARRIER

(71) Applicants: Gilbert W. Mckenna, Revere, MA (US); Ari Eiriksson, South Hamilton, MA (US)

(72) Inventors: Gilbert W. Mckenna, Revere, MA (US); Ari Eiriksson, South Hamilton, MA (US)

(73) Assignee: ANALOGIC CORPORATION, Peabody, MA (US)

(21) Appl. No.: 13/703,989

(22) PCT Filed: Jun. 29, 2010
(86) PCT No.: PCT/US10/40277

§ 371 Date: Dec. 13, 2012

(51) Int. Cl. G01N 1/28

(52) U.S. Cl. CPC G01N 1/28
USPC 137/1; 422/502

(57) ABSTRACT

A micro channel device includes at least one sample processing region (108) that supports a sample for processing by a sample processing apparatus, at least one chamber (120, 126) that stores a fluid, at least one channel (202, 204, 206, 302, 402), and an interface (116) configured to interface with the processing apparatus. Moisture removed from compressed air, which is employed to move the sample and/or a processing agent through the at least one channel, is received by the interface and routed via the at least one channel to the at least one chamber.

### TECHNICAL FIELD

The following generally relates to a sample carrier and more particularly to discarding moisture collected from compressed air used in connection with moving materials in a sample carrier.

### BACKGROUND

Micro channel devices include, but are not limited to, devices which carry a small sample for processing and/or analysis. Such devices have included a plurality of processing regions, processing material chambers, and micro-fluidic channels, and the sample is moved through the device via the micro-fluidic channels from processing station to processing where the sample is sequentially processed by a sample processing system using the processing materials from the chambers. One approach for moving the sample and/or a processing material in connection with the device includes using pressurized air.

With one system, the pressurized air is generated by the sample processing system, for example, through a compressor compressing air from the surrounding environment. Unfortunately, air from the surrounding environment may include moisture, and the moisture may contaminate and/or interfere with the processing of the sample. Exasperating this is that compressing the air increases the moisture of the air. For example, compressing air having 50% humidity from atmospheric pressure (−14.7 lbf, or 65 N) to 30 lbf would double the humidity to about 100%. Various approaches have been used to dry the pressurized air.

One approach includes moving the pressurized air through a desiccant or other drying agent before supplying the air to the micro channel device. However, the desiccant requires additional space and needs to be periodically replaced. With another approach, the moisture is condensed, collected, and boiled and evaporated. This requires a condenser and boiler which increases overall cost and may not be well-suited for a hand-held portable sample processing apparatus. With yet another approach, the moisture is condensed, collected, and drained from the processing apparatus. Unfortunately, this may not suitable for applications where there is no where to route the resulting water.

### SUMMARY

Aspects of the application address the above matters, and others.

In one aspect, a micro channel device includes at least one sample processing region that supports a sample for processing by a sample processing apparatus, at least one chamber that stores a fluid, at least one channel and an interface configured to interface with the processing apparatus. Moisture removed from compressed air, which is employed to move the sample and/or a processing agent through the at least one channel, is received by the interface and routed via the at least one channel to the at least one chamber.

In another aspect, a method includes removing moisture from pressurized air used to move at least one of a sample or a processing agent through one or more channels of a sample carrier, routing the removed moisture to at least one chamber of the sample carrier, and carrying the removed moisture in the at least one chamber.

In another aspect, a sample processing apparatus includes a sample carrier receiving region configured to receive a sample carriers carrying a sample for processing by the sample processing apparatus, at least one sample processing component that processes the sample, a source of compressed air, a moisture collection component that removes moisture from the compressed air to produce dry air, and a mover that employs the dry air to move at least one of the sample or a processing agent on the sample carrier when the sample carrier is loaded in the sample receiving region. The mover moves the removed moisture to a chamber on the sample carrier. The moisture is carried by the sample carrier in the chamber while the sample on the sample carrier is processed.

Those skilled in the art will recognize still other aspects of the present application upon reading and understanding the attached description.

### BRIEF DESCRIPTION OF THE DRAWINGS

The application is illustrated by way of example and not limitation in the figures of the accompanying drawings, in which like references indicate similar elements and in which:

FIG. 1 illustrates an example sample processing apparatus and a sample carrier;

FIG. 2 illustrates an example in which the sample carrier includes a water removal channel and an agent storage chamber used to store water removed during the compression of air after an agent stored in the agent storage chamber is utilized for processing a sample;

FIG. 3 illustrates an example in which a channel of the sample carrier is shared to move a processing agent or a processed sample and water removed during the compression of air;

FIG. 4 illustrates an example in which an unused region of the sample carrier is used to store water removed during the compression of air;

FIG. 5 illustrates an example method for storing moisture from compressed air in an empty agent chamber of the sample carrier;

FIG. 6 illustrates an example method for storing moisture from compressed air in an spare chamber of the sample carrier; and

FIG. 7 illustrates an example method for employing a shared channel to move both water and dry air to a sample carrier.

### DETAILED DESCRIPTION

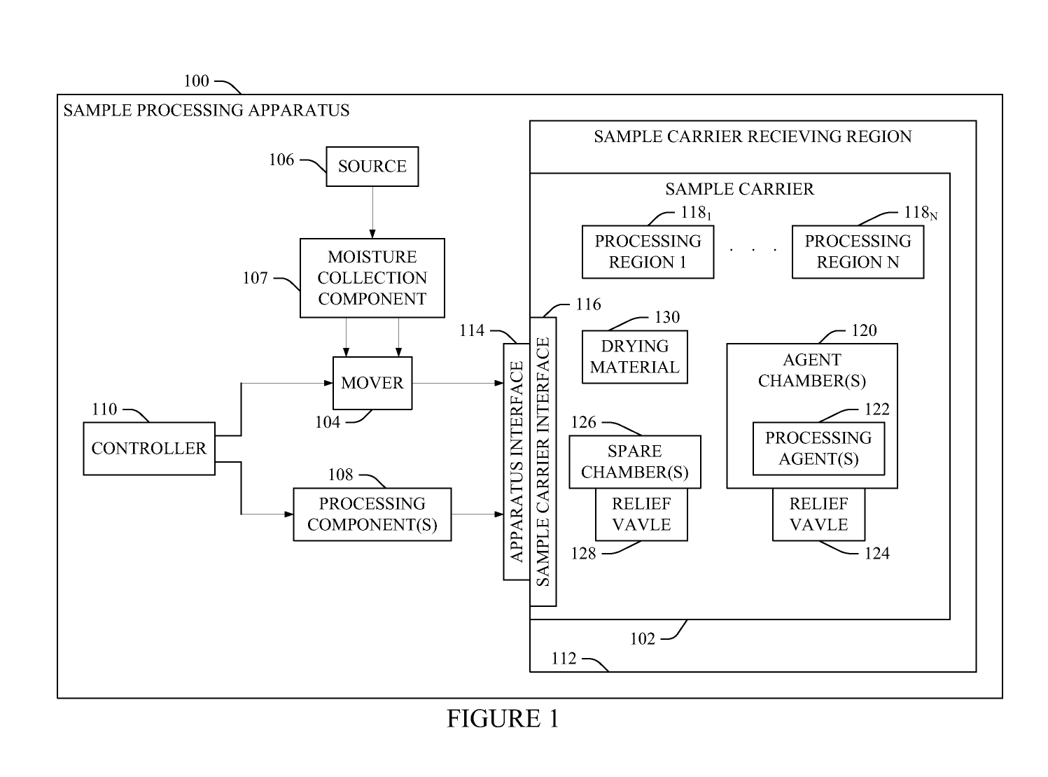

FIG. 1 illustrates a sample processing apparatus 100 for processing one or more samples located on a micro-channel device such as a sample carrier 102. An example of a suitable sample carrier includes, but is not limited to, a biochip, a lab-on-a-chip, and/or other sample carriers. In this example, the processing apparatus 100 may be configured for DNA, enzymatic, protein, and/or other processing and/or analysis of at least one or more bio-samples located on the sample carrier 102. In another embodiment, the sample processing apparatus 100 is configured to process other bio-samples and/or non bio-samples on the sample carrier 102.

The sample processing apparatus 100 includes a mover 104 for moving samples and/or fluids such as agents, air, water, and/or other fluids of the sample carrier 102. In the illustrated embodiment, a source 106 provides pressurized air which is used by the mover 104 to move samples and/or fluids. In one instance, the source 106 includes or interfaces with an air compressor that compresses air, producing the pressurized air. In another instance, the source 106 may include another source of pressurized air. For example, in another embodiment, the source 106 includes bottled air or other pre-compressed air. A moisture collection component 107 condenses or otherwise removes the moisture in the compressed air and collects the condensed moisture (i.e., water).

The sample processing apparatus 100 also includes one or more processing components 108. The one or more processing components 108 are configured for processing one or more samples of the sample carrier 102. A controller 110 controls the mover 104 and/or the processing component(s) 108. The sample processing apparatus 100 also includes a sample carrier receiving region 112 for receiving the sample carrier 102 and/or other sample carriers. An interface 114 provides the channels, valves, etc. for communication (e.g., transfer of pressurized air and condensed moisture to the sample carrier 102) between the sample processing apparatus 100 and the sample carrier 102 when the sample carrier 102 is loaded or installed in the receiving region 112.

The sample carrier 102 includes a complementary interface 116, which provides complementary channels, valves, etc. for communication between the sample processing apparatus 100 and the sample carrier 102 when the sample carrier 102 is loaded or installed in the receiving region 112. The sample carrier 102 also includes a plurality of processing regions 118₁ to 118_{N} (wherein N is an integer), collectively referred to herein as processing regions 118. A sample on the sample carrier 102 is moved from processing station to processing station for processing of the sample via the processing components 108.

The sample carrier 102 further includes one or more processing agent holding regions or chambers 120, which holds one or more processing agents 122 employed when processing the sample. As discussed in greater detail below, in one embodiment, an empty processing agent holding region 120 (e.g., one in which the agent therein has been used for processing) is employed to carry the water collected by the moisture collection component 107. An agent chamber 120 may include a relief valve 124, which releases fluid such as water and/or air from the chamber 120.

In another embodiment, the sample carrier 102 may include one or more spare chambers 126 configured to carry the water collected by the moisture collection component 107. As described in greater detail below, such chambers may be located in otherwise unused regions of the sample carrier 102. This includes regions other than regions where the interface 116, the processing regions 118, and the agent chambers 120 are located. Similar to the agent chamber 120, a spare chamber 108 may include a relief valve 128 for releasing a fluid from the spare chamber 126.

In another embodiment, an empty agent chamber 120 and a spare chamber 126 are individually or concurrently utilized to store the water. By utilizing a previously used portion (e.g., an agent chamber 120) and/or an unused portion (e.g., a spare chamber 126) of the sample carrier 102 to hold water, the apparatus 100 does not need local fluid mass storage and/or an interface to remote fluid mass storage therewith for holding the water.

It is to be appreciated that the water stored on the sample carrier 102 can be discarded with the sample carrier 102 where the sample carrier 102 is disposable, or removed therefrom. The water may also be drained, evaporated, and/or other removed from the sample carrier 102. Furthermore, the sample carrier 102 may also include a drying material 130 such as a desiccant or the like to facilitate drying air moved by the mover 104 to the sample carrier 102. The drying material 130 may be used in connection with a filter or the like for removing particulate such as dust or the like from the drying material.

In the illustrated embodiment, the processing apparatus 100 is configured to be a hand-held, portable apparatus that can be readily carried by an operator. In this configuration, the processing apparatus 100 can be carried and employed at the location where the sample is collected, if desired, or elsewhere. In this configuration, the processing apparatus 100 may also be configured such the operator can operate it with one hand. In another embodiment, the processing apparatus 100 is configured to be a stationary apparatus mounted to or placed on a table, the floor, etc. in a laboratory, office, or the like. In such a configuration, the processing apparatus 100 may be configured to remain at a particular location and process sample carriers 102 loaded therein.

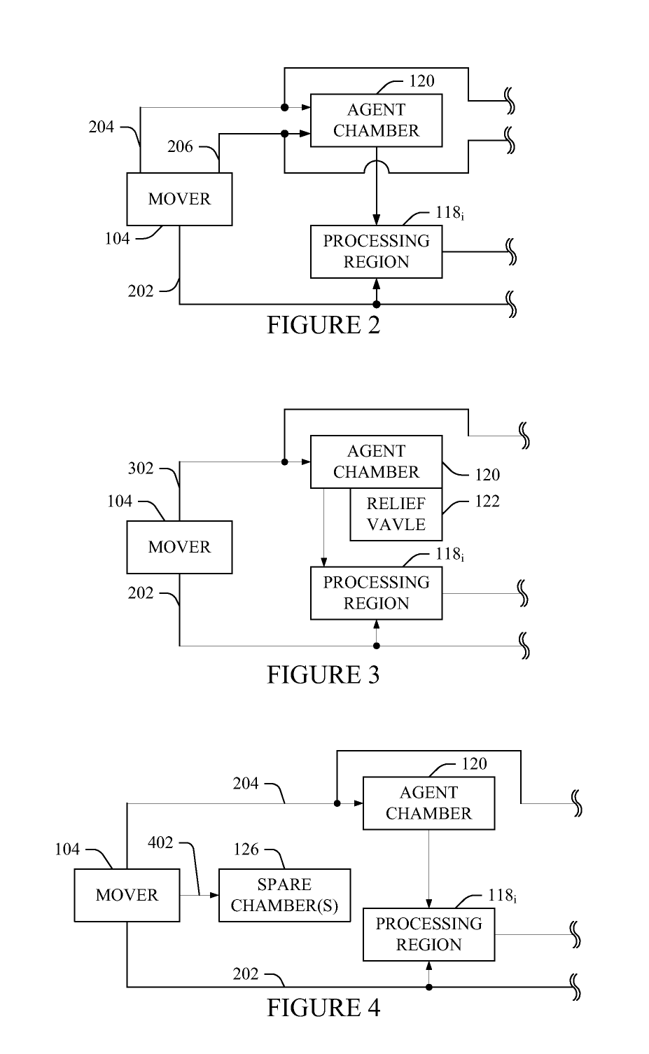

FIG. 2 illustrates an example in which a dedicated channel is used to route water collected by the moisture collection component 107 to an empty agent chamber 120 of the sample carrier 102.

A channel 202 is used to route pressurized air to a processing region 118ᵢ. The pressurized air is used to move a sample from the processing region 118ᵢ to a subsequent processing station 118. In this example, the channel 202 is also used to route pressurized air to one or more other processing regions to move the sample therefrom.

A channel 204 is used to route pressurized air to the agent chamber 120 to route an agent from the agent chamber 120 to the processing region 118ᵢ for processing the sample. In this example, the channel 204 is also used to route pressurized air to one or more other agent chambers 120 to route agents to the processing region 118ᵢ and/or other processing regions 118 for processing the sample.

A channel 206 is used to route water removed from the compressed air by the moisture collection component 107 to an empty agent chamber 120 (e.g., a agent chamber 120 in which the agent stored therein has been moved to the processing region 118ᵢ and used for processing the sample). In this example, the channel 206 is also used to route water to one or more other empty agent chambers 120.

Once moved to an empty agent chamber 120, the water can be carried by the sample carrier 102 while the sample is further processed by other processing regions 118 using other agent from other agent chambers 120. Where the sample carrier 102 is discarded after processing of the sample, the water can be discarded along with the sample carrier 102.

FIG. 3 illustrates an example in which a shared or common channel is used to route the removed water to an empty agent chamber 120. The channel 202 is used to route pressurized air to a processing region 118ᵢ as described herein.

A channel 302 is used to route pressurized air to the agent chamber 120 to route an agent from the agent chamber 120 to the processing region 118ᵢ for processing the sample. The channel 302 is also used in connection with routing agents from other agent chambers 120 to other processing regions 118. In this embodiment, the channel 302 is further used to route water removed from the compressed air by the moisture collection component 107 to one or more of the agent chambers 120.

With this embodiment, the agent chamber 120 includes a relief valve 122. The relief valve may be used, for example, to release fluid such as water, air, etc. from the agent chamber 120. The relief valve 122 allows for the release of air when flushing the channel 302 with dry air to remove any water therein resulting from moving water through the channel 302 to an empty agent chamber 120. In other embodiments, the relief valve 122 may be omitted.

FIG. 4 illustrates an example in which a spare chamber 126 is used to hold water removed from the compressed air by the moisture collection component 107. The channel 202 is used to route pressurized air to a processing region 118ᵢ as described herein, and the channel 204 is used to route pressurized air to the agent chamber 120 as described herein.

A channel 402 is used to route the water removed from the pressurized air to the one or more spare chambers 126. As discussed herein, the one or more spare chambers 126 may be located in regions of the sample carrier 102 that are not being used for processing the sample. As such, the spare chambers 126 can be employed within the same footprint as a sample carrier 102 without the chambers 126.

With respect to FIGS. 204, it is to be appreciated that other embodiments and/or variations of the embodiments are also contemplated herein. For example, in FIG. 4, a shared or common channel may be used to route water to one or more spare chambers 126. In this example, the one or more spare chambers 126 may also include the relief valve 128, which may be similar to the relief valve 122, for releasing a fluid from the spare chamber 126. In another example, the channel 302, for example, in FIG. 3, may also be used to move the sample. Other variations are also contemplated.

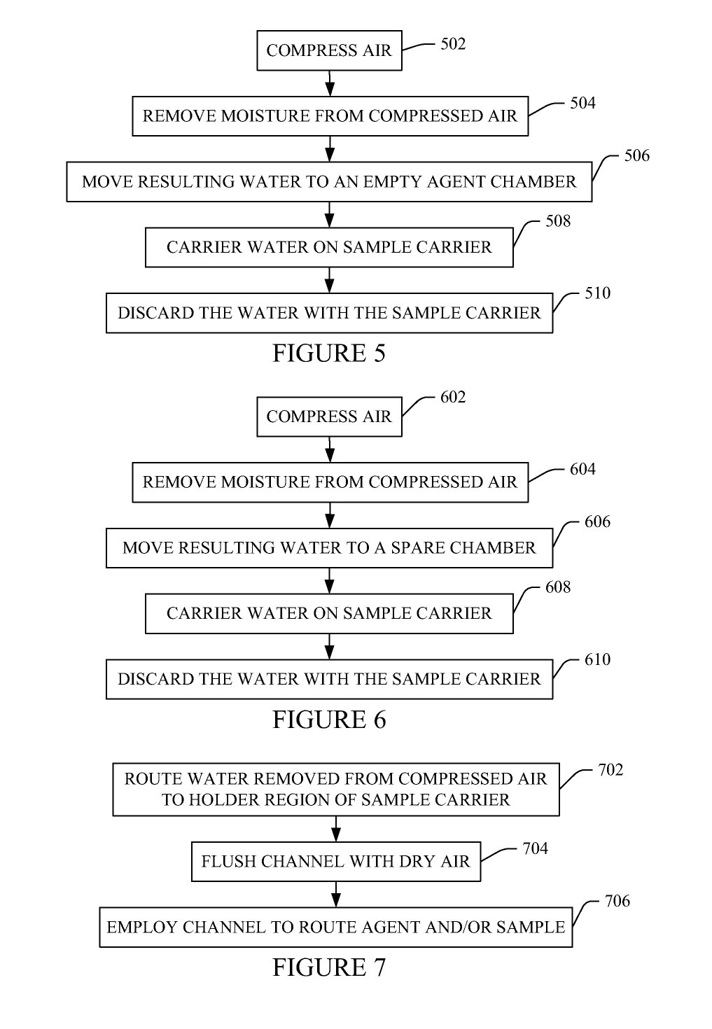

FIG. 5 illustrates a method for storing moisture from compressed air in an empty agent chamber 120 of the sample carrier 102.

At 502, air for moving one or more a sample or a processing agent in the carrier 102 is compressed.

At 504, moisture is condensed from the compressed air and collected.

At 506, the resulting water is routed to an agent chamber 120 in which the agent stored therein has been used for processing the sample.

At 508, the water in the agent chamber 120 is carried by the sample carrier 102 while the sample is further processed.

At 510, the water in the agent chamber 120 is discarded with the sample carrier 102 after processing the sample. Where the sample carrier 102 also includes the drying material 130, the drying material may or may not be discarded along with the sample carrier 102.

FIG. 6 illustrates a method for storing moisture from compressed air in a spare chamber 126 of the sample carrier 102.

At 602, air for moving one or more a sample or a processing agent in the carrier 102 is compressed.

At 604, moisture is removed from the compressed air and collected.

At 606, the resulting water is routed to at least one spare chamber 126.

At 608, the water in the spare chamber 126 is carried by the sample carrier 102 while the sample is further processed.

At 610, the water in the spare chamber 126 is discarded with the sample carrier 102 after processing the sample. Where the sample carrier 102 includes the drying material 130, the drying material may or may not be discarded along with the sample carrier 102.

FIG. 7 illustrates a method for employing a shared channel to move both water and dry air to a sample carrier.

At 702, water removed from compressed air is routed to an agent chamber 120 and/or a spare chamber 126 through a shared or common channel.

At 704, the dry air is used to flush any remaining water from the channel.

At 706, the flushed channel is used to move an agent to a processing region 108 for processing a sample and/or a sample from one processing station 108 to another processing station 108.

The application has been described with reference to various embodiments. Modifications and alterations will occur to others upon reading the application. It is intended that the invention be construed as including all such modifications and alterations, including insofar as they come within the scope of the appended claims and the equivalents thereof.

1. A micro channel device, comprising:
at least one sample processing region that supports a sample for processing by a sample processing apparatus;
at least one chamber that stores a fluid;
at least one channel; and
an interface configured to interface with the sample processing apparatus, wherein moisture removed from compressed air, which is employed to move the sample and/or a processing agent through the at least one channel, is received by the interface and routed via the at least one channel to the at least one chamber.

2. The micro channel device of claim 1, wherein the at least one channel is a dedicated channel used only to route moisture to the chamber.

3. The micro channel device of claim 1, wherein the at least one channel is a shared or common channel used to route the moisture to the chamber and at least one of the sample or the processing agent to a processing region.

4. The micro channel device of claim 1, wherein the chamber includes a relief valve and compressed air used to flush water out of the channel is released through the relief valve.

5. The micro channel device of claim 1, wherein the chamber is an agent chamber that stores the processing agent, and the moisture is routed to the agent chamber after the agent in the chamber is utilized for processing the sample.

6. The micro channel device of claim 1, wherein the chamber is a spare chamber located in a portion of the sample carrier not used to process the sample.

7. The micro channel device of claim 5, wherein the chamber carries the moisture while the sample is being processed by the processing apparatus.

8. The micro channel device of claim 5, wherein the sample carrier is disposable and the moisture stored in the chamber is discarded with the sample carrier.

9. The micro channel device of claim 1, further comprising a drying material used to dry the received compressed air.

10. The micro channel device of claim 9, wherein the drying material is discarded with the sample carrier.

11. The micro channel device of claim 1, wherein the sample is a bio-sample.

12. The micro channel device of claim 1, wherein the sample includes human DNA.

13. The micro channel device of claim 1, wherein the processing apparatus is a hand-held, portable apparatus.

14. A method, comprising:
removing moisture from pressurized air used to move at least one of a sample or a processing agent through one or more channels of a sample carrier;
routing the removed moisture to at least one chamber of the sample carrier; and
carrying the removed moisture in the at least one chamber.

15. The method of claim 14, wherein the carried moisture is discarded with the sample carrier.

16. The method of claim 14, wherein the moisture is carried by the sample carrier while the sample is being processed.

17. The method of claim 15, further comprising: using a dedicated channel to route the removed moisture to the at least one chamber.

18. The method of claim 15, further comprising: using a shared channel to route the removed moisture to the at least one chamber, wherein the shared channel is also used to move the sample and/or the processing agent through the sample carrier.

19. The method of claim 18, further comprising: flushing the channel with dry air after routing the removed water and before routing the sample and/or the processing agent.

20. The method of claim 14, wherein the chamber is a spare chamber located in an unused portion of the sample carrier and dedicated for holding the removed moisture.

21. The method of claim 14, wherein the chamber is an empty processing agent chamber.

22. The method of claim 14, further comprising: drying the compressed air via a drying material.

23. The method of claim 22, wherein the drying material is discarded with the sample carrier.

24. The method of claim 14, wherein the sample is a bio-sample.

25. The method of claim 14, wherein the sample includes human DNA.

26. A sample processing apparatus, comprising:
a sample carrier receiving region configured to receive a sample carrier carrying a sample for processing by the sample processing apparatus;
at least one sample processing component that processes the sample;
a source of compressed air;
a moisture collection component that removes moisture from the compressed air to produce dry air; and
a mover that employs the dry air to move at least one of the sample or a processing agent on the sample carrier when the sample carrier is loaded in the sample receiving region;
wherein the mover moves the removed moisture to a chamber on the sample carrier, where the moisture is carried by the sample carrier in the chamber while the sample on the sample carrier is processed.
